(19) United States
(12) Patent Application Publication
(10) Pub. No.: US 2025/0183983 A1
(43) Pub. Date: Jun. 5, 2025

(54) MULTI-MODULE MEASUREMENT FOR BEAM MANAGEMENT

(71) Applicant: QUALCOMM Incorporated, San Diego, CA (US)

(72) Inventors: Kang GAO, San Diego, CA (US); Yongle WU, San Diego, CA (US); Jun ZHU, San Diego, CA (US); Kang YANG, San Diego, CA (US); Shrenik PATEL, San Diego, CA (US); Raghu Narayan CHALLA, San Diego, CA (US)

(21) Appl. No.: 18/530,053

(22) Filed: Dec. 5, 2023

(51) Int. Cl. H04B 7/06; H04B 17/318; H04W 56/00; H04W 88/02

(52) U.S. Cl. CPC H04B 7/0696; H04B 17/328; H04W 56/0015; H04W 88/02

(57) ABSTRACT

Methods, systems, and devices for wireless communications are described. A user equipment (UE) may measure a signal via a first set of antenna ports of the UE to obtain a first measurement for a first beam pair. The UE may measure, simultaneous to measuring the signal via the first set of antenna ports, the signal via a second set of antenna ports of the UE to obtain a second measurement for a second beam pair. The first set of antenna ports may be different from the second set of antenna ports, such as being positioned at different locations of the UE or being different sub-sets of the same antenna component. The UE may select a beam pair based on the first measurement for the first beam pair and the second measurement for the second beam pair.

### FIELD OF TECHNOLOGY

The following relates to wireless communications, including multi-module measurement for beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multi-module measurement for beam management. For example, the described techniques provide for a user equipment (UE) to measure a single signal, such as a synchronization signal block (SSB), multiple times to obtain multiple beam pair measurements per symbol. In some examples, the UE may use a first set of antenna ports at a first antenna component of the UE to measure an SSB and obtain a first beam pair measurement, and the UE may use a different set of antenna ports at a second antenna component of the UE to measure the same SSB and obtain a second beam pair measurement. In some examples, the UE may divide the antenna ports within an antenna component and use different groups of antenna ports of the antenna component to obtain multiple beam pair measurements. For example, the UE may measure the SSB using a first set of antenna ports of an antenna component to obtain a first beam pair measurement, and the UE may measure the SSB using a second set of antenna ports of the antenna component to obtain a second beam pair measurement. In some examples, the UE may use multiple radio frequency chains to perform the multiple beam pair measurements or to receive the SSB via different sets of antenna ports. For example, the UE may obtain the first beam pair measurement using a first radio frequency chain, and the UE may obtain the second beam pair measurement using a second radio frequency chain.

A method for wireless communications by a UE is described. The method may include measuring a signal via a first set of antenna ports of the UE to obtain a first measurement for a first beam pair, measuring, simultaneous to measuring the signal via the first set of antenna ports, the signal via a second set of antenna ports of the UE to obtain a second measurement for a second beam pair, where the first set of antenna ports is different from the second set of antenna ports, and selecting a beam pair based on the first measurement for the first beam pair and the second measurement for the second beam pair.

A UE for wireless communications is described. The UE may include one or more memories storing processor executable code, and one or more processors coupled with the one or more memories. The one or more processors may individually or collectively operable to execute the code to cause the UE to measure a signal via a first set of antenna ports of the UE to obtain a first measurement for a first beam pair, measure, simultaneous to measuring the signal via the first set of antenna ports, the signal via a second set of antenna ports of the UE to obtain a second measurement for a second beam pair, where the first set of antenna ports is different from the second set of antenna ports, and select a beam pair based on the first measurement for the first beam pair and the second measurement for the second beam pair.

Another UE for wireless communications is described. The UE may include means for measuring a signal via a first set of antenna ports of the UE to obtain a first measurement for a first beam pair, means for measuring, simultaneous to measuring the signal via the first set of antenna ports, the signal via a second set of antenna ports of the UE to obtain a second measurement for a second beam pair, where the first set of antenna ports is different from the second set of antenna ports, and means for selecting a beam pair based on the first measurement for the first beam pair and the second measurement for the second beam pair.

A non-transitory computer-readable medium storing code for wireless communications is described. The code may include instructions executable by one or more processors to measure a signal via a first set of antenna ports of the UE to obtain a first measurement for a first beam pair, measure, simultaneous to measuring the signal via the first set of antenna ports, the signal via a second set of antenna ports of the UE to obtain a second measurement for a second beam pair, where the first set of antenna ports is different from the second set of antenna ports, and select a beam pair based on the first measurement for the first beam pair and the second measurement for the second beam pair.

In some examples of the method, UEs, and non-transitory computer-readable medium described herein, measuring the signal via the first set of antenna ports may include operations, features, means, or instructions for measuring the signal via a first antenna component including the first set of antenna ports; and where measuring the signal via the second set of antenna ports includes and measuring the signal via a second antenna component including the second set of antenna ports, where the first antenna component may be different from the second antenna component.

In some examples of the method, UEs, and non-transitory computer-readable medium described herein, the first antenna component may be positioned at a first location of the UE and the second antenna component may be positioned at a second location of the UE different than the first location.

In some examples of the method, UEs, and non-transitory computer-readable medium described herein, measuring the signal via the first set of antenna ports may include operations, features, means, or instructions for measuring the signal via a first antenna component including the first set of antenna ports; and where measuring the signal via the second set of antenna ports includes and measuring the signal via the first antenna component including the second set of antenna ports, where the first antenna component includes the first set of antenna ports and the second set of antenna ports.

In some examples of the method, UEs, and non-transitory computer-readable medium described herein, the first set of antenna ports and the second set of antenna ports may be at a same location of the UE.

In some examples of the method, UEs, and non-transitory computer-readable medium described herein, a first antenna component configured to communicate and including the first set of antenna ports, the first antenna component may be at a first location of the UE and a second antenna component configured to communicate and including the second set of antenna ports, the second antenna component at a second location of the UE.

In some examples of the method, UEs, and non-transitory computer-readable medium described herein, a first antenna component configured to communicate, where the first antenna component includes the first set of antenna ports and the second set of antenna ports.

Some examples of the method, UEs, and non-transitory computer-readable medium described herein may further include operations, features, means, or instructions for receiving the signal via the first set of antenna ports using a first radio frequency chain and receiving the signal via the second set of antenna ports using a second radio frequency chain.

Some examples of the method, UEs, and non-transitory computer-readable medium described herein may further include operations, features, means, or instructions for estimating a channel based on the first measurement for the first beam pair and the second measurement for the second beam pair, where selecting the beam pair may be based on estimating the channel.

In some examples of the method, UEs, and non-transitory computer-readable medium described herein, the first measurement or the second measurement, or both, include a reference signal received power (RSRP) measurement.

In some examples of the method, UEs, and non-transitory computer-readable medium described herein, the signal includes an SSB.

### BRIEF DESCRIPTION OF THE DRAWINGS

FIG. 1 shows an example of a wireless communications system that supports multi-module measurement for beam management in accordance with one or more aspects of the present disclosure.

FIG. 2 shows an example of a wireless communications system that supports multi-module measurement for beam management in accordance with one or more aspects of the present disclosure.

FIG. 3 shows an example of a process flow that supports multi-module measurement for beam management in accordance with one or more aspects of the present disclosure.

FIGS. 4 and 5 show block diagrams of devices that support multi-module measurement for beam management in accordance with one or more aspects of the present disclosure.

FIG. 6 shows a block diagram of a communications manager that supports multi-module measurement for beam management in accordance with one or more aspects of the present disclosure.

FIG. 7 shows a diagram of a system including a device that supports multi-module measurement for beam management in accordance with one or more aspects of the present disclosure.

FIGS. 8 through 10 show flowcharts illustrating methods that support multi-module measurement for beam management in accordance with one or more aspects of the present disclosure.

### DETAILED DESCRIPTION

A user equipment (UE) may measure signals from a network entity to obtain a measurement for a beam pair including a receive beam of the UE and a transmit beam of the network entity. For example, the network entity may transmit synchronization signal blocks (SSBs) using different transmit beams in different directions. The UE may receive an SSB using a receive beam of the UE, and the UE may obtain a beam pair measurement for the transmit beam of the SSB and the receive beam of the UE. In some wireless communication systems, the UE may measure a single SSB using a single radio frequency chain to obtain a single beam pair measurement per symbol. Some wireless communications systems may support wireless communications in radio frequency spectrums which support a large quantity of beams, such as Frequency Range 2 (FR2). Obtaining a single beam pair measurement per symbol may be insufficient for beam tracking or beam management, such as in systems with a large quantity of beams. For example, in scenarios where beam quality is fading or the UE is rotating, the channel may change quickly, and the UE may be unable to find a suitable beam by performing one beam pair measurement per symbol before the channel degrades.

Techniques described herein support using multiple radio frequency chains to perform multiple beam pair measurements on a single signal from a network entity. For example, a UE may measure a single SSB multiple times to obtain multiple beam pair measurements per symbol. In some examples, the UE may use a first set of antenna ports at a first antenna component of the UE to measure an SSB and obtain a first beam pair measurement, and the UE may use a different set of antenna ports at a second antenna component of the UE to measure the same SSB and obtain a second beam pair measurement. In some examples, the UE may split the elements within an antenna component and use different groups of antenna ports of the antenna component to obtain multiple beam pair measurements. For example, the UE may measure the SSB using a first set of antenna ports of an antenna component to obtain a first beam pair measurement, and the UE may measure the SSB using a second set of antenna ports of the antenna component to obtain a second beam pair measurement. In some examples, the UE may use multiple radio frequency chains to perform the multiple beam pair measurements or to receive the SSB via different sets of antenna ports. For example, the UE may obtain the first beam pair measurement using a first radio frequency chain, and the UE may obtain the second beam pair measurement using a second radio frequency chain.

Aspects of the disclosure are initially described in the context of wireless communications systems. Aspects of the disclosure are further illustrated by and described with reference to apparatus diagrams, system diagrams, and flowcharts that relate to multi-module measurement for beam management.

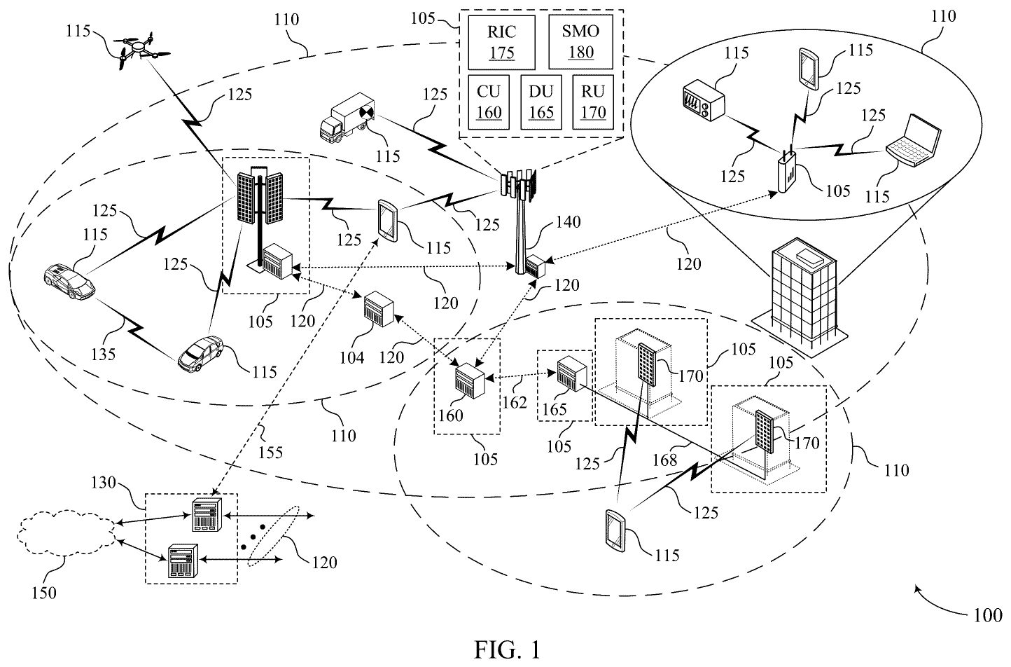

FIG. 1 shows an example of a wireless communications system 100 that supports multi-module measurement for beam management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multi-module measurement for beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may measure signals from a network entity 105 to obtain a measurement for a beam pair. A beam pair may include a receive beam formed at the UE 115 and a transmit beam used by the network entity 105 to transmit a signal. For example, the network entity 105 may transmit SSBs using different transmit beams in different directions. The UE 115 may receive an SSB using a receive beam of the UE 115 and measure the SSB. For example, the UE 115 may measure a reference signal received power (RSRP) of the SSB, and the UE 115 may obtain a beam pair measurement for the transmit beam of the network entity 105 used to transmit the SSB and a receive beam of the UE 115 used to measure the SSB. In some examples, the SSB or antennas at the UE 115 forming the receive beam, or both, may be polarized (e.g., a horizontal polarization or a vertical polarization).

In some wireless communication systems, a UE 115 may measure a single SSB using a single radio frequency chain to obtain a single beam pair measurement per symbol. Using a single radio frequency chain, the UE 115 may obtain one beam pair measurement per SSB transmission from a network entity 105. For example, the UE 115 may measure a first SSB transmitted using a first receive beam during a first symbol to obtain a first beam pair measurement, and the UE 115 may measure a second SSB using the first receive beam during a second symbol to obtain a second beam pair measurement. The first symbol and the second symbol may be contiguous or separate in time.

Some wireless communications systems, such as the wireless communications system 100, may support wireless communications in radio frequency spectrums which support a large quantity of beams, such as Frequency Range 2 (FR2). Based on the large quantity of beams, the UE 115 may have a large quantity of beams to select from for beam management. Obtaining a single beam pair measurement per symbol may be insufficient for beam tracking or beam management, as tracking loss may mitigate beam management information obtained from one beam pair measurement per symbol. For example, in scenarios where beam quality is fading or the UE 115 is rotating, a wireless channel between the UE 115 and the network entity 105 may change quickly. If the channel is changing quickly, the UE 115 may be unable to find a suitable beam by performing one beam pair measurement per symbol before the channel degrades, or previous beam pair measurements may age and be unsuitable for beam management.

Wireless communications systems described herein, such as the wireless communications system 100, may support techniques for a UE 115 to perform multiple beam pair measurements for a single signal from a network entity 105. For example, the UE 115 may measure a single SSB multiple times to obtain multiple beam pair measurements per symbol. In some examples, the UE 115 may use a first set of antenna ports at a first antenna component of the UE 115 to measure an SSB and obtain a first beam pair measurement, and the UE 115 may use a different set of antenna ports at a second antenna component of the UE to measure the same SSB and obtain a second beam pair measurement. For example, the first antenna component may be at a first position on the UE 115, and the second antenna component may be at a second position on the UE 115.

In some examples, the UE 115 may split the elements within an antenna component and use different groups of antenna ports of the antenna component to obtain multiple beam pair measurements. For example, the UE 115 may measure the SSB using a first set of antenna ports of an antenna component to obtain a first beam pair measurement, and the UE 115 may measure the SSB using a second set of antenna ports of the antenna component to obtain a second beam pair measurement. For example, the first set of antenna ports and the second set of antenna ports may belong to a larger group of antenna ports and be located in a similar position on the UE 115.

In some examples, the UE 115 may use multiple radio frequency chains to perform the multiple beam pair measurements or to receive the SSB via different sets of antenna ports. For example, the UE 115 may obtain the first beam pair measurement using a first radio frequency chain, and the UE 115 may obtain the second beam pair measurement using a second radio frequency chain.

In some examples, an antenna component may be referred to as a module. A module or an antenna component may refer to a set of antenna ports which are grouped together. A UE 115 may have multiple antenna components or modules on different sides, faces, or positions of the UE 115. For example, there may be one or more modules on top of the UE 115, one or more modules on each side of the UE 115, and the like. An antenna component or a module may include multiple antenna ports, which the UE 115 may use to form receive beams or transmit beams.

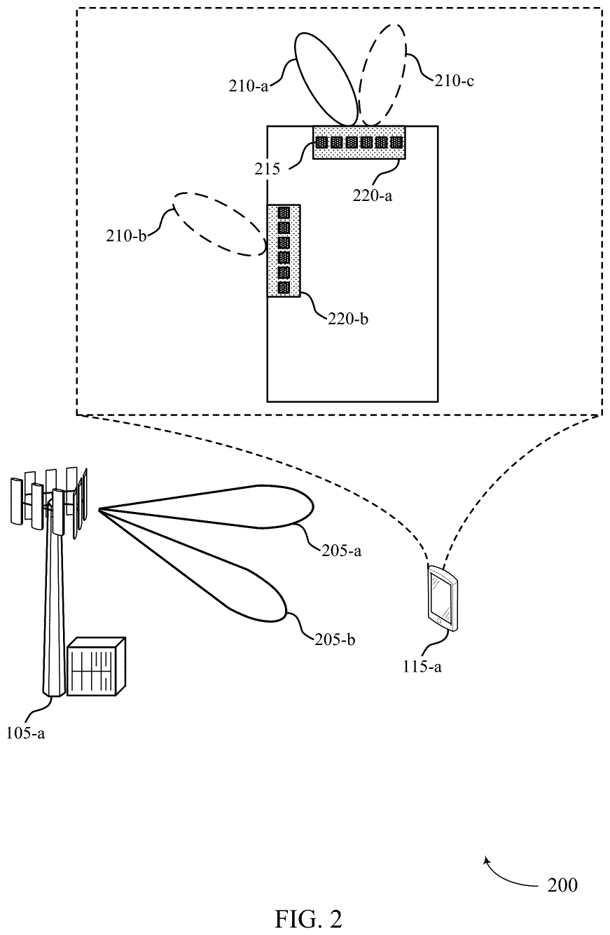

FIG. 2 shows an example of a wireless communications system 200 that supports multi-module measurement for beam management in accordance with one or more aspects of the present disclosure. The wireless communications system 200 may implement aspects of a wireless communications system 100 as described with reference to FIG. 1. For example, the wireless communications system 200 may include a UE 115-a and a network entity 105-a, which may be respective examples of a UE 115 and a network entity 105 described herein.

The network entity 105-a and the UE 115-a may communicate using beamforming. For example, the network entity 105-a may transmit signaling to the UE 115-a using a transmit beam 205, and the UE 115-a may receive the signaling using a receive beam 210. The UE 115-a may be equipped with one or more antenna components, or modules 220. For example, the UE 115-a may have a first module 220-a at a first position or first location of the UE 115-a, and the UE 115-a may have a second module 220-b at a second position or second location of the UE 115-a. Each module may include multiple antenna ports 215. In the example shown by FIG. 2, each module may include six antenna ports 215, although a module 220 may have a different quantity of antenna ports 215. In some examples, different modules 220 may include different quantities of antenna ports 215 or the same quantity of antenna ports 215.

In some examples, the UE 115-a may measure signaling received from the network entity 105-a to obtain a beam pair measurement for a beam pair including a transmit beam 205 and a receive beam 210. For example, the network entity 105-a may transmit an SSB using a transmit beam 205-a, and the UE 115-a may receive the SSB using a receive beam 210-a. The UE 115-a may measure the SSB, such as by measuring an RSRP of the SSB, to obtain a beam pair measurement for a beam pair including the transmit beam 205-a and the receive beam 210-a.

The wireless communications system 200 may support techniques for a UE 115 to perform multiple beam pair measurements on a single signal from a network entity 105. For example, the UE 115-a may use multiple radio frequency chains to obtain multiple beam pair measurements per SSB. In some examples, the UE 115-a may measure multiple beam pairs simultaneously using multiple radio frequency chains and multiple receive beams at the UE 115-a.

In some examples, the UE 115-a may form a receive beam at multiple different modules 220 of the UE 115-a, and each receive beam may receive a same SSB. For example, the UE 115-a may form a receive beam 210-a using antenna ports 215 of a first module 220-a, and the UE 115-a may form a receive beam 210-b using antenna ports 215 of a second module 220-b. The UE 115-a may obtain multiple beam pair measurements by performing measurements on the same SSB. For example, the network entity 105-a may transmit the SSB using transmit beam 205-a, and the UE 115-a may receive the SSB using a receive beam 210-a and a receive beam 210-b. The UE 115-a may obtain a first measurement for a first beam pair including the transmit beam 205-a and the receive beam 210-a, and the UE 115-a may obtain a second measurement for a second beam pair including the transmit beam 205-a and the receive beam 210-b. In some examples, measuring a signal at two different modules 220 (e.g., at the same time) may be referred to as inter-module measurement.

In some examples, inter-module measurement may be used to expedite beam measurements procedures or beam management features which use one module. For example, for dynamic beams, the UE 115-a may generate a beam (e.g., a receive beam 210 or a transmit beam) with dynamic beam weights to adapt to changes to a wireless channel. By using inter-module measurement, the UE 115-a may generate dynamic beams for multiple modules 220 of the UE 115-a. In some examples, inter-module measurement may enable the UE 115-a to track multiple modules or antenna components, or conditions at the multiple modules or antenna components, simultaneously.

In some examples, the UE 115-a may form multiple receive beams at a same module 220 of the UE 115-a, and each receive beam may receive a same SSB. For example, the UE 115-a may form a receive beam 210-a using a portion or a sub-set of antenna ports 215 of a first module 220-a, and the UE 115-a may form a receive beam 210-c using a different portion or a different sub-set of the antenna ports 215 of the first module 220-a. The UE 115-a may, for example, use three antenna ports 215 of the first module 220-a to form the receive beam 210-a, and the UE 115-a may use another three antenna ports 215 of the first module 220-a to form the receive beam 210-b. In some examples, the first grouping of antenna ports 215 forming the receive beam 210-a and the second grouping of antenna ports 215 forming the receive beam 210-c may be each be referred to as a sub-module. The network entity 105-a may transmit an SSB using transmit beam 205-a, and the UE 115-a may receive the SSB using a receive beam 210-a and a receive beam 210-c. The UE 115-a may obtain a first measurement for a first beam pair including the transmit beam 205-a and the receive beam 210-a, and the UE 115-a may obtain a second measurement for a second beam pair including the transmit beam 205-a and the receive beam 210-c. In some examples, measuring a signal at two sub-modules of a module 220 (e.g., at the same time) may be referred to as intra-module measurement.

In some examples, the UE 115-a may perform inter-module measurement or intra-module measurement over multiple SSBs. For example, the network entity 105-a may transmit the SSB using the transmit beam 205-a during a first symbol, and the UE 115-a may generate at least two beam pair measurements using inter-module measurement or intra-module measurement. The network entity 105-a may transmit a second SSB using a transmit beam 205-b during a second symbol, and the UE 115-a may generate at least two additional beam pair measurements using inter-module measurement or intra-module measurement. For example, the UE 115-a may generate four beam pair measurements over two SSB transmissions from the network entity 105-a.

In some examples, the UE 115-a may select a beam pair based on the beam pair measurements. For example, the UE 115-a may perform inter-module measurement or intra-module measurement over one or more SSBs to obtain multiple beam pair measurements for a corresponding multiple beam pairs. The UE 115-a may select a beam pair from the multiple beam pairs based on a beam pair measurement for the selected beam pair. For example, the selected beam pair may correspond to a best beam pair measurement, such as by having a highest RSRP measurement of the beam pair measurements. In some examples, the UE 115-a may transmit an indication of the selected beam pair measurement to the network entity 105-a.

In some examples, inter-module measurement and intra-module measurement may increase at rate at which the UE 115-a performs measurements. For example, the UE 115-a may generate at least double the quantity of measurements (e.g., beam measurements or beam pair measurements) as using a single receive beam.

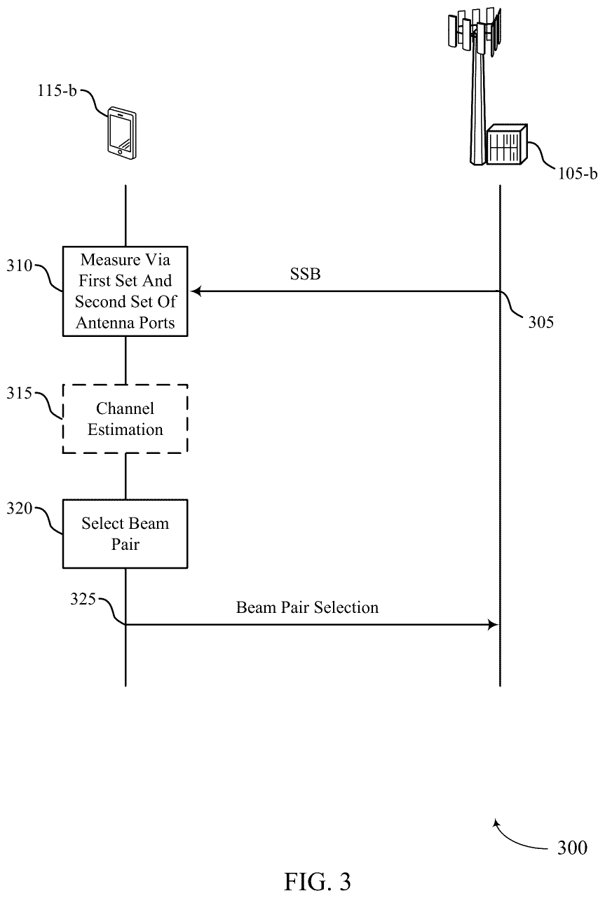

FIG. 3 shows an example of a process flow 300 that supports multi-module measurement for beam management in accordance with one or more aspects of the present disclosure. The process flow 300 may implement aspects of a wireless communications system 100 or a wireless communications system 200. For example, the process flow 300 may be implemented by a UE 115-b or a network entity 105-b, or both, which may be respective examples of a UE 115 and a network entity 105 as described herein. In some examples, some processes or signaling of the process flow 300 may occur in a different order than shown by FIG. 3. Additionally, or alternatively, some processes or signaling shown may not occur, or some processes or signaling not shown may occur.

At 305, the network entity 105-b may transmit a signal to the UE 115-b. For example, the network entity 105-b may transmit an SSB to the UE 115-b using a transmit beam of the network entity 105-b. The UE 115-b may receive the signal from the network entity 105-b. For example, the UE 115-b may receive the signal via a first set of antenna ports using a first radio frequency chain, and the UE 115-b may receive the signal via a second set of antenna ports using a second radio frequency chain.

At 310, the UE 115-b may measure the signal via a first set of antenna ports and a second set of antenna ports. For example, the UE 115-b may measure the signal via the first set of antenna ports of the UE 115-b to obtain a first measurement for a first beam pair. The UE 115-b may measure, simultaneous to measuring the signal via the first set of antenna ports, the signal via the second set of antenna ports of the UE 115-b to obtain a second measurement for a second beam pair. The second set of antenna ports may be different from the second set of antenna ports.

In some examples, the UE 115-b may perform inter-module measurement. For example, the UE 115-b may measure the signal via a first antenna component, or a first module, including the first set of antenna ports, and the UE 115-b may measure the signal via a second antenna component, or a second module, including the second set of antenna ports. The first antenna component may be different from the second antenna component. For example, the first antenna component may be positioned at a first location of the UE 115-b, and the second antenna component may be positioned at a second location of the UE 115-b different from the first location.

In some examples, the UE 115-b may perform intra-module measurement. For example, the UE 115-b may measure the signal via a first antenna component including the first set of antenna ports, and the UE 115-b may measure the signal via the second antenna component including the second set of antenna components. For example, the first antenna component may include both the first set of antenna ports and the second set of antenna ports. In some examples, the first set of antenna ports may be an example of a first sub-module of the first antenna component, and the second set of antenna ports may be an example of a second sub-module of the first antenna component. For example, the first set of antenna ports and the second set of antenna ports may be at a same location of the UE 115-b.

In some examples, the UE 115-b may perform channel estimation based on the measurements. For example, at 315, the UE 115-b may estimate a channel based on the first measurement for the first beam pair and the second measurement for the second beam pair.

At 320, the UE 115-b may select a beam pair based on the measurements. For example, the UE 115-b may select the beam pair based on the first measurement for the first beam pair and the second measurement for the second beam pair. For example, the UE 115-b may select the first beam pair based on the first measurement for the first beam pair having a higher RSRP than other measurements for other beam pairs (e.g., including the second measurement for the second beam pair). In some examples, the UE 115-b may transmit an indication of the selected beam pair based on the first beam pair measurement and the second beam pair measurement to the network entity 105-b at 325.

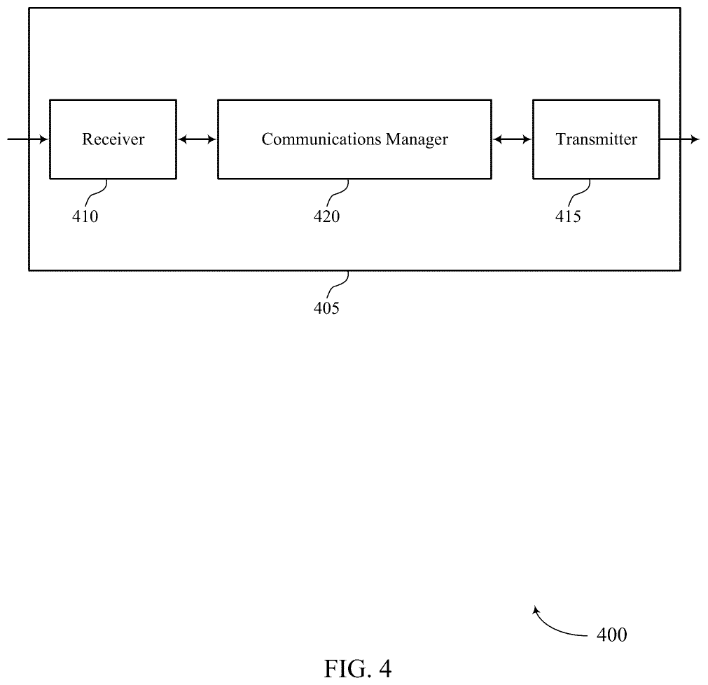

FIG. 4 shows a block diagram 400 of a device 405 that supports multi-module measurement for beam management in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to multi-module measurement for beam management). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to multi-module measurement for beam management). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of multi-module measurement for beam management as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for measuring a signal via a first set of antenna ports of the UE to obtain a first measurement for a first beam pair. The communications manager 420 is capable of, configured to, or operable to support a means for measuring, simultaneous to measuring the signal via the first set of antenna ports, the signal via a second set of antenna ports of the UE to obtain a second measurement for a second beam pair, where the first set of antenna ports is different from the second set of antenna ports. The communications manager 420 is capable of, configured to, or operable to support a means for selecting a beam pair based on the first measurement for the first beam pair and the second measurement for the second beam pair.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

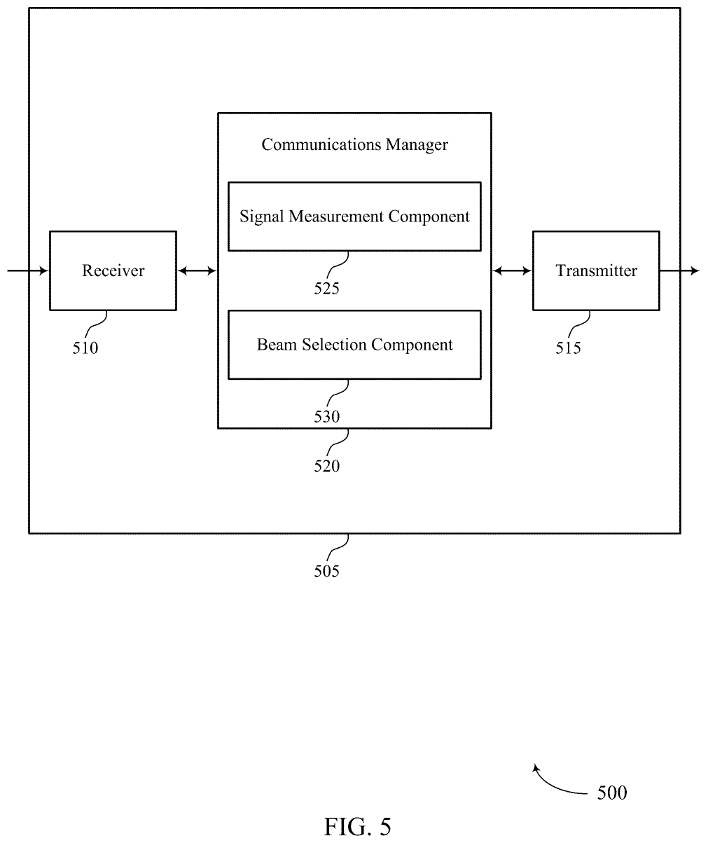

FIG. 5 shows a block diagram 500 of a device 505 that supports multi-module measurement for beam management in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to multi-module measurement for beam management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to multi-module measurement for beam management). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of multi-module measurement for beam management as described herein. For example, the communications manager 520 may include a signal measurement component 525 a beam selection component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The signal measurement component 525 is capable of, configured to, or operable to support a means for measuring a signal via a first set of antenna ports of the UE to obtain a first measurement for a first beam pair. The signal measurement component 525 is capable of, configured to, or operable to support a means for measuring, simultaneous to measuring the signal via the first set of antenna ports, the signal via a second set of antenna ports of the UE to obtain a second measurement for a second beam pair, where the first set of antenna ports is different from the second set of antenna ports. The beam selection component 530 is capable of, configured to, or operable to support a means for selecting a beam pair based on the first measurement for the first beam pair and the second measurement for the second beam pair.

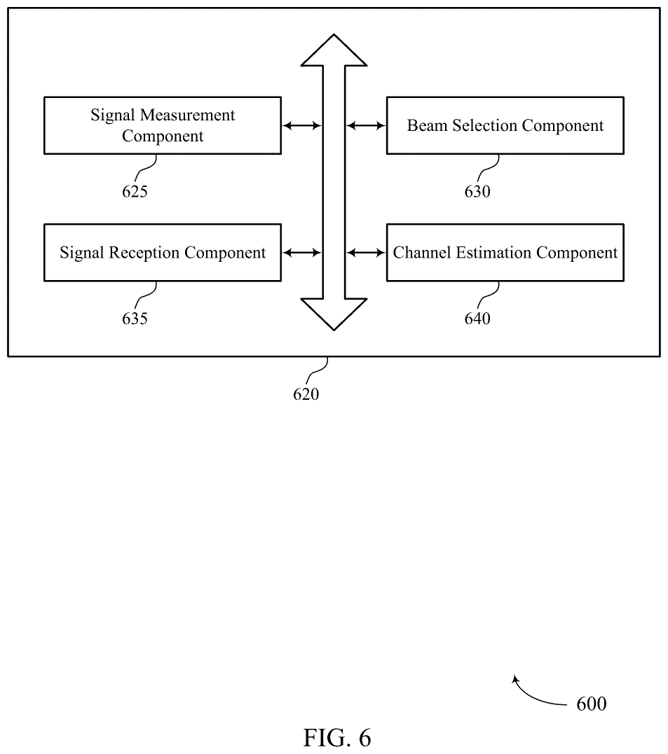

FIG. 6 shows a block diagram 600 of a communications manager 620 that supports multi-module measurement for beam management in accordance with one or more aspects of the present disclosure. The communications manager 620 may be an example of aspects of a communications manager 420, a communications manager 520, or both, as described herein. The communications manager 620, or various components thereof, may be an example of means for performing various aspects of multi-module measurement for beam management as described herein. For example, the communications manager 620 may include a signal measurement component 625, a beam selection component 630, a signal reception component 635, a channel estimation component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The signal measurement component 625 is capable of, configured to, or operable to support a means for measuring a signal via a first set of antenna ports of the UE to obtain a first measurement for a first beam pair. In some examples, the signal measurement component 625 is capable of, configured to, or operable to support a means for measuring, simultaneous to measuring the signal via the first set of antenna ports, the signal via a second set of antenna ports of the UE to obtain a second measurement for a second beam pair, where the first set of antenna ports is different from the second set of antenna ports. The beam selection component 630 is capable of, configured to, or operable to support a means for selecting a beam pair based on the first measurement for the first beam pair and the second measurement for the second beam pair.

In some examples, to support measuring the signal via the first set of antenna ports, the signal measurement component 625 is capable of, configured to, or operable to support a means for measuring the signal via a first antenna component including the first set of antenna ports; and where measuring the signal via the second set of antenna ports includes. In some examples, to support measuring the signal via the first set of antenna ports, the signal measurement component 625 is capable of, configured to, or operable to support a means for measuring the signal via a second antenna component including the second set of antenna ports, where the first antenna component is different from the second antenna component.

In some examples, the first antenna component is positioned at a first location of the UE and the second antenna component is positioned at a second location of the UE different than the first location.

In some examples, to support measuring the signal via the first set of antenna ports, the signal measurement component 625 is capable of, configured to, or operable to support a means for measuring the signal via a first antenna component including the first set of antenna ports; and where measuring the signal via the second set of antenna ports includes. In some examples, to support measuring the signal via the first set of antenna ports, the signal measurement component 625 is capable of, configured to, or operable to support a means for measuring the signal via the first antenna component including the second set of antenna ports, where the first antenna component includes the first set of antenna ports and the second set of antenna ports.

In some examples, the first set of antenna ports and the second set of antenna ports are at a same location of the UE.

In some examples, the signal reception component 635 is capable of, configured to, or operable to support a means for receiving the signal via the first set of antenna ports using a first radio frequency chain. In some examples, the signal reception component 635 is capable of, configured to, or operable to support a means for receiving the signal via the second set of antenna ports using a second radio frequency chain.

In some examples, the channel estimation component 640 is capable of, configured to, or operable to support a means for estimating a channel based on the first measurement for the first beam pair and the second measurement for the second beam pair, where selecting the beam pair is based on estimating the channel.

In some examples, the first measurement or the second measurement, or both, include an RSRP measurement. In some examples, the signal includes an SSB.

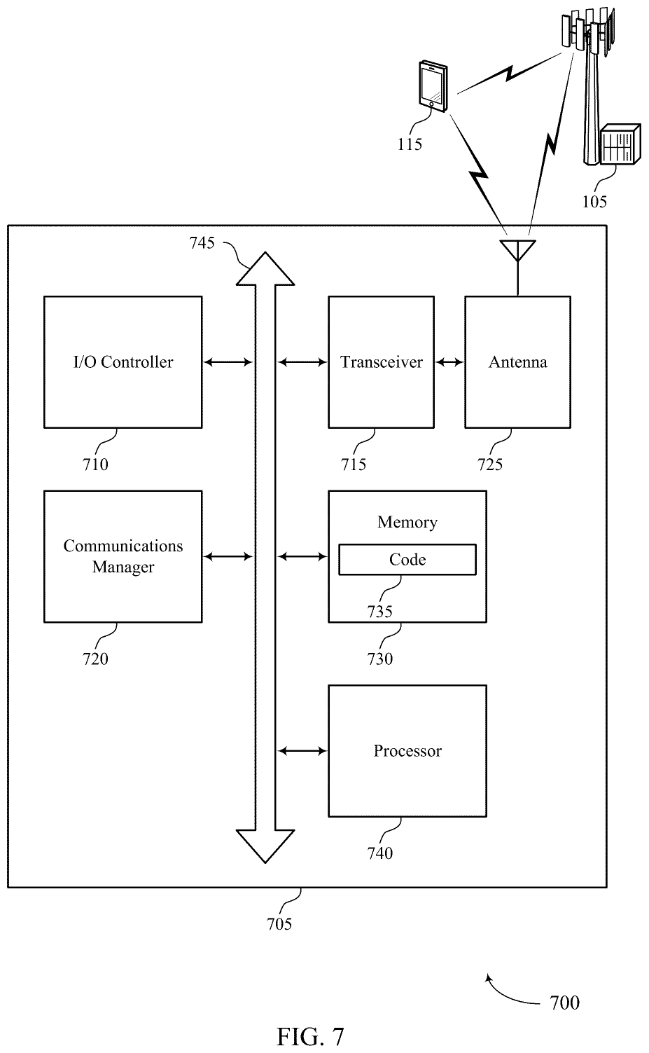

FIG. 7 shows a diagram of a system 700 including a device 705 that supports multi-module measurement for beam management in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting multi-module measurement for beam management). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. As such, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for measuring a signal via a first set of antenna ports of the UE to obtain a first measurement for a first beam pair. The communications manager 720 is capable of, configured to, or operable to support a means for measuring, simultaneous to measuring the signal via the first set of antenna ports, the signal via a second set of antenna ports of the UE to obtain a second measurement for a second beam pair, where the first set of antenna ports is different from the second set of antenna ports. The communications manager 720 is capable of, configured to, or operable to support a means for selecting a beam pair based on the first measurement for the first beam pair and the second measurement for the second beam pair.

By including or configuring the communications manager 720 in accordance with examples as described herein, the device 705 may support techniques for improved communication reliability, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of multi-module measurement for beam management as described herein, or the at least one processor 740 and the at least one memory 730 may be otherwise configured to, individually or collectively, perform or support such operations.

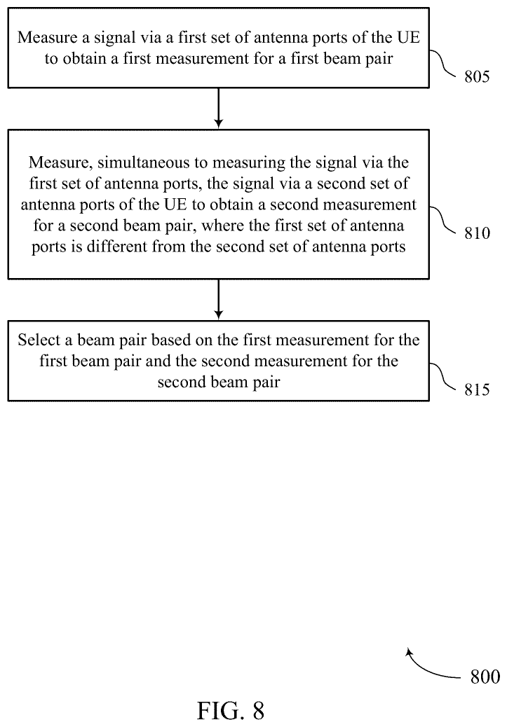

FIG. 8 shows a flowchart illustrating a method 800 that supports multi-module measurement for beam management in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include measuring a signal via a first set of antenna ports of the UE to obtain a first measurement for a first beam pair. The operations of block 805 may be performed in accordance with examples as disclosed herein. In some examples, aspects of the operations of 805 may be performed by a signal measurement component 625 as described with reference to FIG. 6.

At 810, the method may include measuring, simultaneous to measuring the signal via the first set of antenna ports, the signal via a second set of antenna ports of the UE to obtain a second measurement for a second beam pair, where the first set of antenna ports is different from the second set of antenna ports. The operations of block 810 may be performed in accordance with examples as disclosed herein. In some examples, aspects of the operations of 810 may be performed by a signal measurement component 625 as described with reference to FIG. 6.

At 815, the method may include selecting a beam pair based on the first measurement for the first beam pair and the second measurement for the second beam pair. The operations of block 815 may be performed in accordance with examples as disclosed herein. In some examples, aspects of the operations of 815 may be performed by a beam selection component 630 as described with reference to FIG. 6.

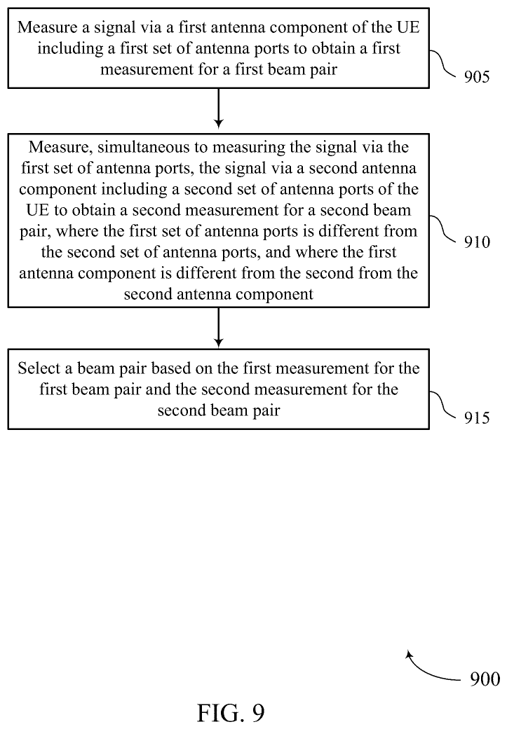

FIG. 9 shows a flowchart illustrating a method 900 that supports multi-module measurement for beam management in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include measuring a signal via a first antenna component of the UE including a first set of antenna ports to obtain a first measurement for a first beam pair. The operations of block 905 may be performed in accordance with examples as disclosed herein. In some examples, aspects of the operations of 905 may be performed by a signal measurement component 625 as described with reference to FIG. 6.

At 910, the method may include measuring, simultaneous to measuring the signal via the first set of antenna ports, the signal via a second antenna component including a second set of antenna ports of the UE to obtain a second measurement for a second beam pair, where the first set of antenna ports is different from the second set of antenna ports, and the first antenna component is different from the second from the second antenna component. The operations of block 910 may be performed in accordance with examples as disclosed herein. In some examples, aspects of the operations of 910 may be performed by a signal measurement component 625 as described with reference to FIG. 6.

At 915, the method may include selecting a beam pair based on the first measurement for the first beam pair and the second measurement for the second beam pair. The operations of block 915 may be performed in accordance with examples as disclosed herein. In some examples, aspects of the operations of 915 may be performed by a beam selection component 630 as described with reference to FIG. 6.

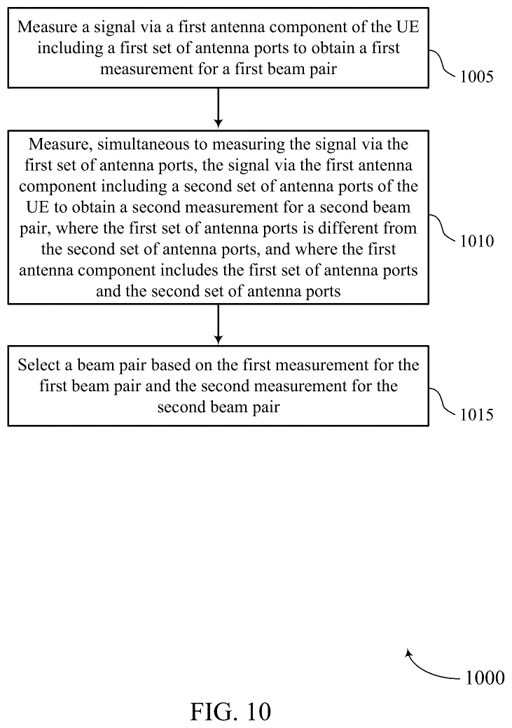

FIG. 10 shows a flowchart illustrating a method 1000 that supports multi-module measurement for beam management in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include measuring a signal via a first antenna component including a first set of antenna ports of the UE to obtain a first measurement for a first beam pair. The operations of block 1005 may be performed in accordance with examples as disclosed herein. In some examples, aspects of the operations of 1005 may be performed by a signal measurement component 625 as described with reference to FIG. 6.

At 1010, the method may include measuring, simultaneous to measuring the signal via the first set of antenna ports, the signal via the first antenna component including a second set of antenna ports to obtain a second measurement for a second beam pair, where the first set of antenna ports is different from the second set of antenna ports, and where the first antenna component includes the first set of antenna ports and the second set of antenna ports. The operations of block 1010 may be performed in accordance with examples as disclosed herein. In some examples, aspects of the operations of 1010 may be performed by a signal measurement component 625 as described with reference to FIG. 6.

At 1015, the method may include selecting a beam pair based on the first measurement for the first beam pair and the second measurement for the second beam pair. The operations of block 1015 may be performed in accordance with examples as disclosed herein. In some examples, aspects of the operations of 1015 may be performed by a beam selection component 630 as described with reference to FIG. 6.

The following provides an overview of aspects of the present disclosure:
Aspect 1: A method for wireless communications at a UE, comprising: measuring a signal via a first set of antenna ports of the UE to obtain a first measurement for a first beam pair; measuring, simultaneous to measuring the signal via the first set of antenna ports, the signal via a second set of antenna ports of the UE to obtain a second measurement for a second beam pair, wherein the first set of antenna ports is different from the second set of antenna ports; and selecting a beam pair based at least in part on the first measurement for the first beam pair and the second measurement for the second beam pair.
Aspect 2: The method of aspect 1, wherein measuring the signal via the first set of antenna ports comprises: measuring the signal via a first antenna component comprising the first set of antenna ports; and wherein measuring the signal via the second set of antenna ports comprises: measuring the signal via a second antenna component comprising the second set of antenna ports, wherein the first antenna component is different from the second antenna component.
Aspect 3: The method of aspect 2, wherein the first antenna component is positioned at a first location of the UE and the second antenna component is positioned at a second location of the UE different than the first location.
Aspect 4: The method of any of aspects 1 through 3, wherein measuring the signal via the first set of antenna ports comprises: measuring the signal via a first antenna component comprising the first set of antenna ports; and wherein measuring the signal via the second set of antenna ports comprises: measuring the signal via the first antenna component comprising the second set of antenna ports, wherein the first antenna component comprises the first set of antenna ports and the second set of antenna ports.
Aspect 5: The method of aspect 4, wherein the first set of antenna ports and the second set of antenna ports are at a same location of the UE.
Aspect 6: The method of any of aspects 1 through 5, further comprising: a first antenna component configured to communicate and comprising the first set of antenna ports, the first antenna component is at a first location of the UE; and a second antenna component configured to communicate and comprising the second set of antenna ports, the second antenna component at a second location of the UE.
Aspect 7: The method of any of aspects 1 through 6, further comprising: a first antenna component configured to communicate, wherein the first antenna component comprises the first set of antenna ports and the second set of antenna ports.
Aspect 8: The method of any of aspects 1 through 7, further comprising: receiving the signal via the first set of antenna ports using a first radio frequency chain; and receiving the signal via the second set of antenna ports using a second radio frequency chain.
Aspect 9: The method of any of aspects 1 through 8, further comprising: estimating a channel based at least in part on the first measurement for the first beam pair and the second measurement for the second beam pair, wherein selecting the beam pair is based at least in part on estimating the channel.
Aspect 10: The method of any of aspects 1 through 9, wherein the first measurement or the second measurement, or both, include a reference signal received power (RSRP) measurement.
Aspect 11: The method of any of aspects 1 through 10, wherein the signal comprises a synchronization signal block (SSB).
Aspect 12: A UE for wireless communications, comprising one or more memories storing processor-executable code, and one or more processors coupled with the one or more memories and individually or collectively operable to execute the code to cause the UE to perform a method of any of aspects 1 through 11.
Aspect 13: A UE for wireless communications, comprising at least one means for performing a method of any of aspects 1 through 11.
Aspect 14: A non-transitory computer-readable medium storing code for wireless communications, the code comprising instructions executable by one or more processors to perform a method of any of aspects 1 through 11.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
measure a signal via a first set of antenna ports of the UE to obtain a first measurement for a first beam pair;
measure, simultaneous to measuring the signal via the first set of antenna ports, the signal via a second set of antenna ports of the UE to obtain a second measurement for a second beam pair, wherein the first set of antenna ports is different from the second set of antenna ports; and
select a beam pair based at least in part on the first measurement for the first beam pair and the second measurement for the second beam pair.

2. The UE of claim 1, wherein, to measure the signal via the first set of antenna ports, the one or more processors are individually or collectively operable to execute the code to cause the UE to:
measure the signal via a first antenna component comprising the first set of antenna ports; and wherein measuring the signal via the second set of antenna ports comprises:
measure the signal via a second antenna component comprising the second set of antenna ports, wherein the first antenna component is different from the second antenna component.

3. The UE of claim 2, wherein the first antenna component is positioned at a first location of the UE and the second antenna component is positioned at a second location of the UE different than the first location.

4. The UE of claim 1, wherein, to measure the signal via the first set of antenna ports, the one or more processors are individually or collectively operable to execute the code to cause the UE to:
measure the signal via a first antenna component comprising the first set of antenna ports; and wherein measuring the signal via the second set of antenna ports comprises:
measure the signal via the first antenna component comprising the second set of antenna ports, wherein the first antenna component comprises the first set of antenna ports and the second set of antenna ports.

5. The UE of claim 4, wherein the first set of antenna ports and the second set of antenna ports are at a same location of the UE.

6. The UE of claim 1, further comprising:
a first antenna component configured to communicate and comprising the first set of antenna ports, the first antenna component is at a first location of the UE; and
a second antenna component configured to communicate and comprising the second set of antenna ports, the second antenna component at a second location of the UE.

7. The UE of claim 1, further comprising:
a first antenna component configured to communicate, wherein the first antenna component comprises the first set of antenna ports and the second set of antenna ports.

8. The UE of claim 1, wherein the one or more processors are individually or collectively further operable to execute the code to cause the UE to:
receive the signal via the first set of antenna ports using a first radio frequency chain; and
receive the signal via the second set of antenna ports using a second radio frequency chain.

9. The UE of claim 1, wherein the one or more processors are individually or collectively further operable to execute the code to cause the UE to:
estimate a channel based at least in part on the first measurement for the first beam pair and the second measurement for the second beam pair, wherein selecting the beam pair is based at least in part on estimating the channel.

10. The UE of claim 1, wherein the first measurement or the second measurement, or both, include a reference signal received power (RSRP) measurement.

11. The UE of claim 1, wherein the signal comprises a synchronization signal block (SSB).

12. A method for wireless communications at a user equipment (UE), comprising:
measuring a signal via a first set of antenna ports of the UE to obtain a first measurement for a first beam pair;
measuring, simultaneous to measuring the signal via the first set of antenna ports, the signal via a second set of antenna ports of the UE to obtain a second measurement for a second beam pair, wherein the first set of antenna ports is different from the second set of antenna ports; and
selecting a beam pair based at least in part on the first measurement for the first beam pair and the second measurement for the second beam pair.

13. The method of claim 12, wherein measuring the signal via the first set of antenna ports comprises:
measuring the signal via a first antenna component comprising the first set of antenna ports; and wherein measuring the signal via the second set of antenna ports comprises:
measuring the signal via a second antenna component comprising the second set of antenna ports, wherein the first antenna component is different from the second antenna component.

14. The method of claim 13, wherein the first antenna component is positioned at a first location of the UE and the second antenna component is positioned at a second location of the UE different than the first location.

15. The method of claim 12, wherein measuring the signal via the first set of antenna ports comprises:
measuring the signal via a first antenna component comprising the first set of antenna ports; and wherein measuring the signal via the second set of antenna ports comprises:
measuring the signal via the first antenna component comprising the second set of antenna ports, wherein the first antenna component comprises the first set of antenna ports and the second set of antenna ports.

16. The method of claim 15, wherein the first set of antenna ports and the second set of antenna ports are at a same location of the UE.

17. The method of claim 12, further comprising:
receiving the signal via the first set of antenna ports using a first radio frequency chain; and
receiving the signal via the second set of antenna ports using a second radio frequency chain.

18. The method of claim 12, further comprising:
estimating a channel based at least in part on the first measurement for the first beam pair and the second measurement for the second beam pair, wherein selecting the beam pair is based at least in part on estimating the channel.

19. The method of claim 12, wherein the first measurement or the second measurement, or both, include a reference signal received power (RSRP) measurement.

20. The method of claim 12, wherein the signal comprises a synchronization signal block (SSB).

21. A user equipment (UE) for wireless communications, comprising:
means for measuring a signal via a first set of antenna ports of the UE to obtain a first measurement for a first beam pair;
means for measuring, simultaneous to measuring the signal via the first set of antenna ports, the signal via a second set of antenna ports of the UE to obtain a second measurement for a second beam pair, wherein the first set of antenna ports is different from the second set of antenna ports; and
means for selecting a beam pair based at least in part on the first measurement for the first beam pair and the second measurement for the second beam pair.

22. A non-transitory computer-readable medium storing code for wireless communications at a user equipment (UE), the code comprising instructions executable by one or more processors to:
measure a signal via a first set of antenna ports of the UE to obtain a first measurement for a first beam pair;
measure, simultaneous to measuring the signal via the first set of antenna ports, the signal via a second set of antenna ports of the UE to obtain a second measurement for a second beam pair, wherein the first set of antenna ports is different from the second set of antenna ports; and
select a beam pair based at least in part on the first measurement for the first beam pair and the second measurement for the second beam pair.

23. The non-transitory computer-readable medium of claim 22, wherein the instructions to measure the signal via the first set of antenna ports are executable by the one or more processors to:
measure the signal via a first antenna component comprising the first set of antenna ports; and wherein measuring the signal via the second set of antenna ports comprises:
measure the signal via a second antenna component comprising the second set of antenna ports, wherein the first antenna component is different from the second antenna component.

24. The non-transitory computer-readable medium of claim 23, wherein the first antenna component is positioned at a first location of the UE and the second antenna component is positioned at a second location of the UE different than the first location.

25. The non-transitory computer-readable medium of claim 22, wherein the instructions to measure the signal via the first set of antenna ports are executable by the one or more processors to:
measure the signal via a first antenna component comprising the first set of antenna ports; and wherein measuring the signal via the second set of antenna ports comprises:
measure the signal via the first antenna component comprising the second set of antenna ports, wherein the first antenna component comprises the first set of antenna ports and the second set of antenna ports.

26. The non-transitory computer-readable medium of claim 25, wherein the first set of antenna ports and the second set of antenna ports are at a same location of the UE.

27. The non-transitory computer-readable medium of claim 22, wherein the instructions are further executable by the one or more processors to:
receive the signal via the first set of antenna ports using a first radio frequency chain; and
receive the signal via the second set of antenna ports using a second radio frequency chain.

28. The non-transitory computer-readable medium of claim 22, wherein the instructions are further executable by the one or more processors to:
estimate a channel based at least in part on the first measurement for the first beam pair and the second measurement for the second beam pair, wherein selecting the beam pair is based at least in part on estimating the channel.

29. The non-transitory computer-readable medium of claim 22, wherein the first measurement or the second measurement, or both, include a reference signal received power (RSRP) measurement.

30. The non-transitory computer-readable medium of claim 22, wherein the signal comprises a synchronization signal block (SSB).
